(19) United States
(12) Patent Application Publication
(10) Pub. No.: US 2026/0255335 A1
(43) Pub. Date: Aug. 27, 2026

(54) Methods and Systems for Efficient Deployment of Transmit Diversity in Wireless Communication Devices

(71) Applicant: Motorola Mobility LLC, Chicago, IL (US)

(72) Inventors: John Vitale, Chicago, IL (US); Armin W. Klomsdorf, Chicago, IL (US); John R. Mura, Clarendon Hills, IL (US); Patrick A. Cox, Gurnee, IL (US)

(21) Appl. No.: 19/065,662

(22) Filed: Feb. 27, 2025

(51) Int. Cl. H04W 72/044; H04W 52/18; H04W 72/52

(52) U.S. Cl. CPC H04W 72/0473; H04W 52/18; H04W 72/52

(57) ABSTRACT

Methods and systems efficiently deploy transmit diversity in wireless communication devices by predicting an expected transmit power increase based on operating characteristics and network resource allocation and comparing this increase to a threshold. If the increase exceeds the threshold, the device operates in dual transmit mode, optimizing power consumption and device efficiency. Embodiments can include factors such as antenna imbalance and maximum power reduction, ensuring dual transmit mode is engaged only when beneficial. This approach conserves battery life and reduces heat generation, improving user experience.

### BACKGROUND

### Technical Field

This disclosure relates generally to wireless electronic communication devices, and more particularly to wireless electronic communication devices supporting dual transmit mode operations.

### Background Art

In the rapidly evolving field of wireless communication, the demand for higher data throughput and extended coverage has led to the development of new power classes and the implementation of dual transmit modes in electronic devices. Traditionally, single transmit chains have been sufficient to meet power requirements, but the advent of higher bandwidths and the need for increased power have necessitated the use of dual transmit chains. This shift presents significant challenges, particularly in achieving the desired power levels without compromising device efficiency and user experience. It would be advantageous to have improved systems and methods for efficient deployment of transmit diversity in electronic devices supporting wireless communication capabilities.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates a wireless communication system that supports power efficient transmit diversity in accordance with one or more embodiments of the disclosure.

FIG. 3 illustrates one explanatory method in accordance with one or more embodiments of the disclosure.

FIG. 4 illustrates one or more embodiments method steps in accordance with one or more embodiments of the disclosure.

FIG. 5 illustrates a table of expected transmit power increases as a function of one or more factors in accordance with one or more embodiments of the disclosure.

FIG. 6 illustrates another explanatory method in accordance with one or more embodiments of the disclosure.

FIG. 7 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to predicting, by one or more processors of the electronic device, an expected transmit power increase as a function of a combination of one or more factors corresponding to operating characteristics of the electronic device and a resource allocation factor corresponding to a resource allocation provided by a network with which a communication device of the electronic device is in communication and comparing, by the one or more processors, the expected transmit power increase to a threshold. In one or more embodiments, when the expected power increase exceeds the threshold, the method comprises causing, by the one or more processors, the communication device to operate in the dual transmit mode of operation.

Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved.

Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to determine an expected transmit power increase amount for the communication device as a function of a combination of electronic device operating characteristic factors and a resource allocation factor associated with a resource allocation provided to the communication device by a network and only cause the communication device to operate in the dual transmit mode of operation when the expected transmit power increase amount exceeds an expected power increase threshold as described herein. The non-processor circuits may include, but are not limited to, a radio receiver, a radio transmitter, signal drivers, clock circuits, power source circuits, and user input devices.

As such, these functions may be interpreted as steps of a method to perform determining, by one or more processors, whether an expected transmit power increase amount determined from a combination of an antenna imbalance factor occurring between antennas of a plurality of antennas operable with a communication device of the electronic device, an implementation factor associated with a physical design of the electronic device, and a maximum power reduction factor corresponding to resource block and modulation allocations assigned by a network in communication with the communication device exceeds a threshold. In one or more embodiments, when the expected transmit power increase amount exceeds the threshold, the method comprises causing the communication device to operate in the dual transmit mode of operation.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, in the rapidly evolving field of wireless communication, the demand for higher data throughput and extended coverage has led to the development of new power classes and the implementation of dual transmit modes in electronic devices. While single transmit chains have traditionally been sufficient to meet power requirements, modern networks, and particularly 5G networks, offering higher bandwidths require the use of dual transmit chains to achieve the higher bandwidth benefits. The requirement for dual chain transmission presents challenges in a wireless communication device. These challenges are particularly difficult in achieving the desired power levels without compromising device efficiency and user experience.

Existing solutions often struggle with the limitations naturally associated with dual transmit systems, such as antenna imbalances and increased power consumption. These issues can lead to reduced battery life and elevated device temperatures, which are not adequately addressed by current designs.

Moreover, the physical constraints of handset form factors make designing two equally performing antennas challenging, resulting in suboptimal total radiated power improvements. Consequently, there is a pressing need for a method that can efficiently manage these challenges, ensuring that the benefits of dual transmit modes are realized without the drawbacks that currently hinder their effectiveness.

To wit, despite the potential benefits of dual transmit chains, several challenges and disadvantages are associated with their implementation in mobile devices. One significant issue is the imbalance that naturally occurs between the two antennas used in dual transmit configurations. Due to physical constraints and design limitations, achieving identical performance from both antennas is often not feasible. This imbalance can lead to less than optimal total radiated power (TRP) improvements, resulting in increased power consumption and heat generation without a corresponding enhancement in communication performance. Additionally, the use of dual transmit chains can exacerbate issues related to antenna isolation and waveform cancellation, further degrading the effective isotropic radiated power (EIRP) and overall device efficiency.

Advantageously, embodiments of the disclosure address these challenges by providing methods and systems to efficiently deploy transmit diversity in electronic devices. In one or more embodiments, the methods and systems include a dynamic selection process that determines whether a device operates in dual transmit mode or reverts to single transmit mode based on a calculated effective TRP improvement.

In one or more embodiments, this calculation considers various factors, including antenna imbalances, antenna isolation, and maximum power reduction (MPR) due to network resource allocation. In one or more embodiments, by comparing the calculated TRP improvement to a predefined efficiency threshold, the method ensures that the additional power consumption and heat generation associated with dual transmit mode are justified by a meaningful increase in radiated power. Advantageously, this approach not only optimizes device performance but also conserves battery life and mitigates thermal issues, thereby enhancing the overall user experience.

In one or more embodiments, a method pertains to a process implemented in an electronic device that is capable of operating in either a dual transmit mode or a single transmit mode. In one or more embodiments, the process involves predicting, by one or more processors within the electronic device, an expected increase in transmit power. In one or more embodiments, this prediction is based on a combination of factors related to the operating characteristics of the electronic device and a resource allocation factor provided by a network with which the device communicates.

In one or more embodiments, the process further includes comparing the predicted transmit power increase to a predefined threshold. If the predicted increase exceeds this threshold, the process causes the communication device to switch to the dual transmit mode of operation. This approach ensures that the device only utilizes the dual transmit mode when beneficial, thereby optimizing power consumption.

Advantageously, this approach allows the device to enhance power consumption and thermal management by engaging the dual transmit mode only when beneficial, thereby conserving battery life and reducing unnecessary heat generation. In one or more embodiments, the method uses real-time data processing to evaluate the potential benefits of dual transmission, ensuring that the device operates efficiently under varying network conditions and usage scenarios.

By incorporating factors such as antenna imbalance and network resource allocation, the method advantageously provides a tailored response to the device's current environment, improving overall performance and user experience. This dynamic adjustment mechanism addresses the challenges of dual transmit systems, such as increased power consumption and thermal issues, by ensuring that the additional resources are utilized only when they contribute to a meaningful improvement in communication performance.

In one or more embodiments, an electronic device includes a communication device capable of functioning in both a single transmit mode and a dual transmit mode, each linked to distinct power classes. In one or more embodiments, the single transmit mode is associated with a first power class, while the dual transmit mode is linked to a second, higher power class.

In one or more embodiments, the device incorporates one or more processors that collaborate with the communication device to assess an anticipated transmit power increase. In one or more embodiments, this assessment is based on a combination of factors, including the operating characteristics of the electronic device and a resource allocation factor provided by a network.

In one or more embodiments, the processors are configured to prompt the communication device to switch to the dual transmit mode only when the anticipated transmit power increase exceeds a predefined threshold. This setup ensures that the device operates in the dual transmit mode only when advantageous, thereby optimizing power consumption and improving device efficiency.

Advantageously, the electronic device optimizes the performance and efficiency of operating in both single and dual transmit modes. By incorporating a communication device that can switch between these modes, the electronic device allows for dynamic adaptation to varying network conditions and device requirements. The processors within the device are configured to assess the expected transmit power increase based on a combination of operating characteristic factors and network resource allocation. This assessment ensures that the device only switches to the dual transmit mode when the anticipated power increase surpasses a predefined threshold.

This selective switching mechanism results in several technical benefits. First, it enhances power efficiency by preventing unnecessary operation in the dual transmit mode, thereby conserving battery life and reducing heat generation. This is particularly advantageous in mobile devices where battery life is a critical concern.

Second, the invention improves overall device performance by ensuring that the dual transmit mode is utilized only when it provides a meaningful improvement in communication capabilities, such as increased data throughput or extended coverage. Additionally, embodiments of the disclosure address the challenges associated with antenna imbalances and resource allocation in dual transmit systems.

By factoring in these elements, the device can make informed decisions about mode switching, leading to more stable and reliable communication. This approach not only optimizes the use of available resources but also enhances the user experience by maintaining efficient and effective communication under diverse conditions. Overall, embodiments of the disclosure provide a robust solution for managing power and performance in modern electronic communication devices.

In one or more embodiments, a method in an electronic device involves determining, by one or more processors, whether an anticipated increase in transmit power surpasses a predefined threshold. In one or more embodiments, this determination is based on a combination of factors, including an antenna imbalance factor occurring between antennas of multiple antennas operable with a communication device of the electronic device, an implementation factor associated with the physical design of the electronic device, and a maximum power reduction factor corresponding to resource block and modulation allocations assigned by a network in communication with the communication device. In one or more embodiments, the implementation factor may also account for physical characteristics of the overall system at the receiver and the antenna, as well as the processing system and algorithms employed at the receiving end at the radio access node (gNB) or base station.

In one or more embodiments, when the anticipated increase in transmit power surpasses the threshold, the method comprises causing the communication device to operate in the dual transmit mode of operation. This approach ensures that the dual transmit mode is engaged only when it provides a meaningful improvement in communication performance, thereby optimizing power consumption and enhancing device efficiency.

Advantageously, this method offers notable technical advantages by optimizing the operation of electronic devices in wireless communication systems. By determining whether an anticipated transmit power increase, calculated from a combination of an antenna imbalance factor, an implementation factor, and a maximum power reduction factor, surpasses a predefined threshold, the method ensures that the device operates in the dual transmit mode only when beneficial. This selective operation enhances power efficiency by preventing unnecessary activation of the dual transmit mode, thereby conserving battery life and reducing heat generation.

The antenna imbalance factor accounts for performance discrepancies between multiple antennas, while the implementation factor considers the physical design constraints of the device, and the maximum power reduction factor reflects network-imposed limitations on power output. As noted above, the implementation factor can also take into consideration the overall system implementation including the receiving end and signal processing employed in the system, as well as the characteristics of the receiving antenna implementation.

Together, these factors provide a thorough assessment of the potential benefits of dual transmission, ensuring that the device engages this mode only when it results in a meaningful improvement in communication performance, such as increased data throughput or extended coverage. This approach not only optimizes resource utilization but also enhances the overall user experience by maintaining efficient and effective communication under diverse conditions.

Other advantages offered by embodiments of the disclosure will be described below. Still others will be obvious to those of ordinary skill in the art having the benefit of this disclosure.

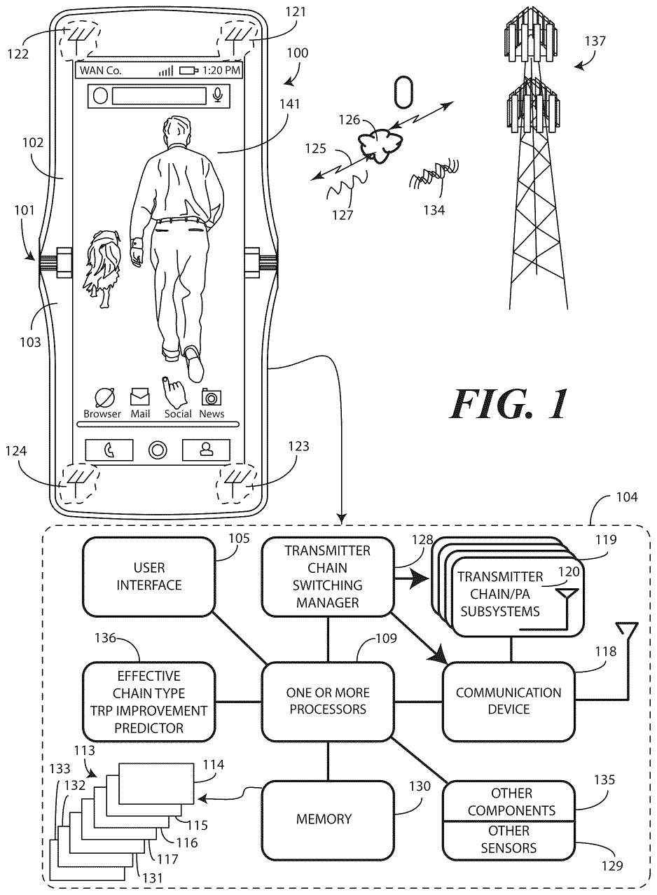

Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, multimedia players, and so forth. Still other types of electronic devices can be configured in accordance with one or more embodiments of the disclosure as will be readily appreciated by those of ordinary skill in the art having the benefit of this disclosure.

Illustrating by example, the electronic device 100 can be any one of a host of different types of devices, including but not limited to, a mobile cellular phone, satellite phone, or smart phone, a laptop, a netbook, an ultra-book, a networked smartwatch or networked sports/exercise watch, and/or a tablet computing device or similar device that can include wireless communication functionality. Indeed, the electronic device 100 can be used as, and also be referred to as, a system, device, subscriber unit, subscriber station, mobile station (MS), mobile, mobile device, remote station, remote terminal, user terminal, terminal, user agent, user device, a Session Initiation Protocol (SIP) phone, a wireless local loop (WLL) station, a personal digital assistant (PDA), computer workstation, a handheld device having wireless connection capability, a computing device, or other processing devices connected to a wireless modem.

The explanatory electronic device 100 illustrated in FIG. 1 includes a first device housing 102 and a second device housing 103. In one or more embodiments, a hinge assembly 101 couples the first device housing 102 to the second device housing 103.

In one or more embodiments, the first device housing 102 is selectively pivotable about the hinge assembly 101 relative to the second device housing 103. For example, in one or more embodiments the first device housing 102 is selectively pivotable about the hinge assembly 101 between a closed position and an axially displaced open position, which is shown in FIG. 1.

In other embodiments the electronic device 100 will include no hinge assembly 101 and instead will include a single device housing. While the electronic device 100 of FIG. 1 is a “clamshell” device, when the electronic device includes a single device housing, it is sometimes referred to as a “candy bar” device. Other mechanical configurations for the device housing will be obvious to those of ordinary skill in the art having the benefit of this disclosure.

In one or more embodiments the first device housing 102 and the second device housing 103 are manufactured from a rigid material such as a rigid thermoplastic, metal, or composite material, although other materials can be used. Still other constructs will be obvious to those of ordinary skill in the art having the benefit of this disclosure. In the illustrative embodiment of FIG. 1, the electronic device 100 includes a single hinge assembly. However, in other embodiments two or more hinges can be incorporated into the electronic device 100 to allow it to be folded in multiple locations.

This illustrative electronic device 100 of FIG. 1 includes a display 105. The display 105 can optionally be touch-sensitive. In one embodiment where the display 105 is touch-sensitive, the display 105 can serve as a primary user interface of the electronic device 100. Users can deliver user input to the display 105 of such an embodiment by delivering touch input from a finger, stylus, or other objects disposed proximately with the display 105.

In one embodiment, the display 105 is configured as an organic light emitting diode (OLED) display fabricated on a flexible plastic substrate, thereby making the display 105 a flexible display 141. This allows the display 105 to be flexible so as to deform when the first device housing 102 pivots about the hinge assembly 101 relative to the second device housing 103. In one or more embodiments, the OLED display is constructed on flexible plastic substrates can allow the flexible display 141 to bend with various bending radii.

In one or more embodiments the flexible display 141 may be formed from multiple layers of flexible material such as flexible sheets of polymer or other materials. In this illustrative embodiment, the flexible display 141 is fixedly coupled to the first device housing 102 and the second device housing 103. The flexible display 141 spans the hinge assembly 101 in this illustrative embodiment.

Features can be incorporated into the first device housing 102 and/or the second device housing 103. Examples of such features include an imager or an optional speaker port, which are disposed on the rear side of the electronic device 100 in this embodiment but could be placed on the front side as well.

In this illustrative embodiment, a user interface component, which may be a button or touch sensitive surface, can also be disposed along the rear side of the first device housing 102. As noted, any of these features are shown being disposed on the rear side of the electronic device 100 in this embodiment, but could be located elsewhere, such as on the front side in other embodiments. In other embodiments, these features may be omitted. Other features can be added and can be located on the front of one or both of the first device housing 102 and/or the second device housing 103, sides of one or both of the first device housing 102 and/or the second device housing 103, or in other locations as well.

A block diagram schematic 104 of the electronic device 100 is also shown in FIG. 1. In one or more embodiments, the block diagram schematic 104 can be configured as a printed circuit board assembly disposed within either or both of the first device housing 102 or the second device housing 103 of the electronic device 100.

Various components can be electrically coupled together by conductors or a bus disposed along one or more printed circuit boards. For example, some components of the block diagram schematic 104 can be configured as a first electronic circuit fixedly situated within the first device housing 102, while other components of the block diagram schematic 104 can be configured as a second electronic circuit fixedly situated within the second device housing 103. A flexible substrate can then span the hinge assembly 101 to electrically couple the first electronic circuit to the second electronic circuit.

It should be noted that the block diagram schematic 104 includes many components that are optional, but which are included in an effort to demonstrate how varied electronic devices configured in accordance with embodiments of the disclosure can be. Thus, it is to be understood that the block diagram schematic 104 of FIG. 1 is provided for illustrative purposes only and for illustrating components of one electronic device 100 in accordance with embodiments of the disclosure. The block diagram schematic 104 of FIG. 1 is not intended to be a complete schematic diagram of the various components required for an electronic device 100. Therefore, other electronic devices in accordance with embodiments of the disclosure may include various other components not shown in FIG. 1 or may include a combination of two or more components or a division of a particular component into two or more separate components and still be within the scope of the present disclosure.

In one or more embodiments, the electronic device 100 includes one or more processors 109. The one or more processors 109 can be a microprocessor, a group of processing components, one or more Application Specific Integrated Circuits (ASICs), programmable logic, or other type of processing device. The one or more processors 109 can be operable with the various components of the electronic device 100. The one or more processors 109 can be configured to process and execute executable software code to perform the various functions of the electronic device 100. A storage device, such as memory 130, can optionally store the executable software code used by the one or more processors 109 during operation.

In one or more embodiments, the one or more processors 109 are further responsible for performing the primary functions of the electronic device 100. For example, in one embodiment the one or more processors 109 comprise one or more circuits operable to present presentation information, such as images, text, and video, on the flexible display 141. The executable software code used by the one or more processors 109 can be configured as one or more modules 113 that are operable with the one or more processors 109. Such modules 113 can store instructions, control algorithms, and so forth.

In one embodiment, the one or more processors 109 are responsible for running the operating system environment 114. The operating system environment 114 can include a kernel, one or more drivers 115, and an application service layer 116, and an application layer 117. The operating system environment 114 can be configured as executable code operating on one or more processors or control circuits of the electronic device 100.

In one or more embodiments, the one or more processors 109 are responsible for managing the applications of the electronic device 100. In one or more embodiments, the one or more processors 109 are also responsible for launching, monitoring and killing the various applications and the various application service modules. The applications of the application layer 117 can be configured as clients of the application service layer 116 to communicate with services through application program interfaces (APIs), messages, events, or other inter-process communication interfaces.

In this illustrative embodiment, the electronic device 100 also includes a communication device 118 that can be configured for wireless communication with one or more other devices or networks. The networks can include a wide area network, a local area network, and/or personal area network. The communication device 118 may also utilize wireless technology for communication, such as, but are not limited to, peer-to-peer or ad hoc communications, and other forms of wireless communication. The communication device 118 can include wireless communication circuitry, one of a receiver, a transmitter, or transceiver, and one or more antennas.

In one or more embodiments, the communication device 118 comprises a communication subsystem 119 that supports multiple transmission uplinks by a plurality of radio frequency (RF) transmit chains 120 configurable for transmit diversity or multiple-input multiple-output (MIMO) modes in either a single data layer or a two or more data layer mode. in one or more embodiments. The RF transmit chains 120 comprise a first and a second transmit chains. However, in other embodiments the communication subsystem 119 can include more than two RF transmit chains 120. In addition, the plurality of RF transmit chains 120 can include different subsets that support concurrent transmission on different communication frequency bands.

A transmit chain switching manager 128 can select various combinations of RF transmit chains 120 to perform transmit diversity in two or more different communication frequency bands. Illustrating by example, the transmit chain switching manager 128 can cause the communication subsystem 119 to operate in a single transmit mode of operation, a dual transmit mode of operation, or another mode of operation.

The communication device 118 comprising the communication subsystem 119 can comprise a MIMO antenna array comprising a plurality of antennas configured for MIMO communication 134 with other remote electronic devices, servers, base stations, and so forth, across a network 126. By including a MIMO antenna array, the transmit chain switching manager 128 is able to perform transmit switching to support both fifth generation of mobile communications (5G) UL CA communication 127 and 5G uplink MIMO communication 134 across the network 126.

Accordingly, in one or more embodiments the transmit chain switching manager 128 can perform uplink transmit switching 125 as required and defined in the 3GPP specifications. This allows the transmit chain switching manager 128 to dynamically switch between uplink MIMO (which is high throughput) and the typically lower frequency FDD band coverages.

In the illustrative embodiment of FIG. 1, the MIMO antenna array consists of four antennas 121,122,123,124, with a first antenna 121 being positioned in an upper righthand corner (as viewed in FIG. 1) of the first device housing 102 and a second antenna 122 being positioned in a left-hand corner of the first device housing 102. A third antenna 123 is positioned at the lower righthand corner of the second device housing 103, while a fourth antenna 124 is positioned at the lower left-hand corner of the second device housing 103.

While four antennas 121,122,123,124 are shown as defining the MIMO antenna array in FIG. 1, it should be noted that embodiments of the disclosure, and in particular dynamic MIMO antenna array optimization techniques, are not limited to only MIMO antenna arrays having four antennas. While MIMO antenna arrays including four antennas are commonly utilized in electronic devices such as smartphones today, embodiments of the disclosure contemplate that soon electronic devices will be equipped with six antennas, eight antennas, or higher numbers of antennas defining MIMO antenna arrays in the future.

Accordingly, while a four-antenna element MIMO antenna array is used illustratively to explain how transmit switching times can work, it will be obvious to those of ordinary skill in the art having the benefit of this disclosure that these dynamic optimization techniques can equally be applied—and likely to produce additional benefits—in MIMO systems having more than six antenna elements.

In one or more embodiments, an effective chain type transmit power improvement predictor 136 can be operable with the communication device 118 and its subsystems to more efficiently manage transmit diversity of the communication device 118. Illustrating by example, since the communication device 118 capable of operating in a single transmit mode of operation having associated therewith a first power class and a dual transmit mode of operation having associated therewith a second power class that is a higher power class than the first power class, in one or more embodiments the effective chain type transmit power improvement predictor 136 can determine an expected transmit power increase amount for the communication device 118.

In one or more embodiments, the effective chain type transmit power improvement predictor 136 determines the expected power increase as a function of a combination of electronic device operating characteristic factors and a resource allocation factor associated with a resource allocation provided to the communication device 118 by the network 137. In one or more embodiments, the effective chain type transmit power improvement predictor 136 only causes the communication device 118 to operate in the dual transmit mode of operation when the expected transmit power increase amount exceeds an expected power increase threshold. In one or more embodiments, the expected power increase threshold is between 0.5 dB and 1.0 dB, inclusive. However, other expected power increase thresholds will be obvious to those of ordinary skill in the art having the benefit of this disclosure.

In one or more embodiments, the communication device 118 uses a first transmit chain and a second transmit chain when operating in the dual transmit mode of operation. However, the communication device 118 omits the use of the second transmit chain when operating in the single transmit mode of operation.

As noted above, the communication device 118 and the communication subsystem 119 can comprise a plurality of antennas. In operation, these antennas can become unbalanced. Moreover, the physical construction of the electronic device 100 itself, including the placement of the antennas within the electronic device 100 relative to the other components, can cause the plurality of antennas to operate in the real world less perfectly than they would in theoretical isolation. Accordingly, the physical state of the electronic device 100 can result in less transmission power reaching the network 137 in practice than in theory.

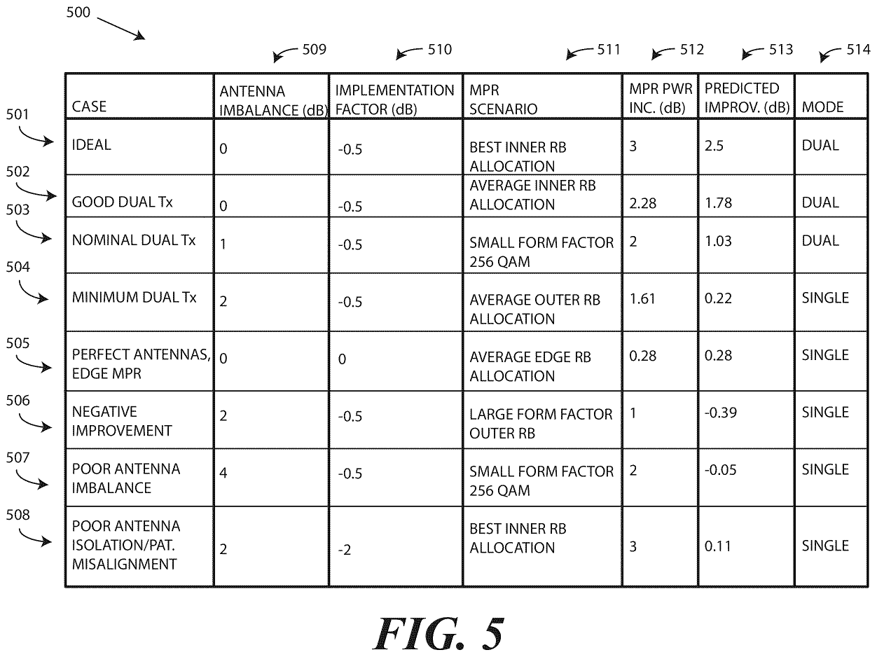

Given the fact that the antennas can become unbalanced, and that the physical state of the electronic device 100 can give rise to imperfect operation, in one or more embodiments the effective chain type transmit power improvement predictor 136 considers other factors in estimating the expected transmit power increase amount. Illustrating by example, in one or more embodiments the electronic device operating characteristic factors considered by the effective chain type transmit power improvement predictor 136 comprise an antenna imbalance factor occurring between antennas of the plurality of antennas carried by the electronic device and one or more implementation factors characterized by a physical state of the electronic device. Examples of these factors, and examples of the expected transmit power increase amount, will be described below with reference to FIG. 5.

In an illustrative embodiment, the electronic device operating characteristic factors considered by the effective chain type transmit power improvement predictor 136 comprise an antenna isolation factor associated with antennas of the plurality of antennas, an antenna pattern misalignment factor associated with the antennas of the plurality of antennas, a waveform cancelation factor associated with the antennas of the plurality of antennas, and/or combinations thereof. In one or more embodiments, the resource allocation factor considered by the effective chain type transmit power improvement predictor 136 comprises a maximum power reduction factor corresponding to resource block and modulation allocations assigned by the network.

The transmit chain switching manager 128 and the effective chain type transmit power improvement predictor 136 can be configured as a hardware module operable with the one or more processors 109 in one or more embodiments. In other embodiments, the transmit chain switching manager 128 and the effective chain type transmit power improvement predictor 136 are configured as software or firmware operating on the one or more processors 109. In still other embodiments, the transmit chain switching manager 128 and the effective chain type transmit power improvement predictor 136 are configured as a hardware component integrated within the one or more processors 109. Other configurations for the transmit chain switching manager 128 and the effective chain type transmit power improvement predictor 136 will be obvious to those of ordinary skill in the art having the benefit of this disclosure.

In one or more embodiments, the memory 130 stores the combination of electronic device operating characteristic factors 131 and a resource allocation factor 132 associated with a resource allocation provided to the communication device 118 by the network 137. When calculated, the memory 130 can store the expected transmit power increase amount 133 as well.

In one or more embodiments, the effective chain type transmit power improvement predictor 136 compute the expected transmit power increase amount 133 only at certain times. Illustrating by example, in one or more embodiments the effective chain type transmit power improvement predictor 136 determines the expected transmit power increase amount 133 when an uplink grant from the network 137 has changed, device power has changed, the data per device state (DSI) has changed, or the antenna switch diversity (ASdiv) has changed. Other criteria used to trigger the computation of the expected transmit power increase amount 133 will be obvious to those of ordinary skill in the art having the benefit of this disclosure.

In one or more embodiments, the inclusion of the effective chain type transmit power improvement predictor 136 provides a mechanism for determining when the communication device 118 should operate in dual transmit mode versus reverting to single transmit mode. In one or more embodiments, the effective chain type transmit power improvement predictor 136 calculates an effective total radiated power (TRP) improvement.

In one or more embodiments, this calculation considers various factors, including antenna imbalances, maximum power reduction (MPR) due to resource block (RB) and modulation allocations, and implementation factors such as antenna isolation and pattern misalignment. In one or more embodiments, the effective chain type transmit power improvement predictor 136 sets a threshold for transmit power improvement, which is based on the increased current draw required for dual transmit mode compared to single transmit mode.

In one or more embodiments, if the calculated transmit power improvement is below this threshold, the communication device 118 reverts to single transmit mode to conserve power and reduce heat generation. In one or more embodiments, the threshold can be dynamically adjusted based on device states, such as low battery or charging conditions, to optimize power efficiency and device performance. This approach ensures that the communication device 118 engages dual transmit mode only when the benefits outweigh the costs, thereby enhancing battery life and managing thermal output effectively.

As noted above, in one or more embodiments the effective chain type transmit power improvement predictor 136 considers an antenna imbalance factor occurring between antennas of the plurality of antennas carried by the electronic device and one or more implementation factors characterized by a physical state of the electronic device. In one or more embodiments, the one or more implementation factors comprise an antenna isolation factor associated with antennas of the plurality of antennas, an antenna pattern misalignment factor associated with the antennas of the plurality of antennas, a waveform cancelation factor associated with the antennas of the plurality of antennas, and/or combinations thereof. In one or more embodiments, the resource allocation factor comprises a maximum power reduction factor corresponding to resource block and modulation allocations assigned by the network.

The effective chain type transmit power improvement predictor 136 benefits from considering an antenna imbalance factor because this factor can directly impact the accuracy of predicting the expected transmit power increase amount. Antenna imbalance occurs when the performance of multiple antennas in a device is not uniform, often due to physical constraints and design limitations present in compact electronic devices.

This imbalance can lead to suboptimal total radiated power (TRP) improvements, as the weaker antenna may not contribute effectively to the overall transmission power, thereby reducing the efficiency of dual transmit mode operations. By incorporating the antenna imbalance factor, the effective chain type transmit power improvement predictor 136 can more accurately assess the potential benefits of engaging the dual transmit mode, ensuring that the device only switches to this mode when the anticipated power increase justifies the additional power consumption and thermal output. This approach not only optimizes power efficiency but also enhances device performance by preventing unnecessary activation of dual transmit mode, thereby conserving battery life and maintaining device temperature within acceptable limits.

The effective chain type transmit power improvement predictor 136 benefits from considering an antenna isolation factor because this factor can also directly influence the accuracy of predicting the expected transmit power increase amount. Antenna isolation refers to the degree to which antennas in a multi-antenna system are able to operate independently without interference from each other.

Poor antenna isolation can lead to increased electromagnetic interference, which can degrade the effective isotropic radiated power (EIRP) and overall communication performance. What's more, poor antenna isolation can also degrade the signal transmit quality. Illustrating by example, this can manifest itself in the form of increased error vector magnitude (EVM), signal to noise ratio (SNR), or other similar metrics.

By incorporating the antenna isolation factor, the effective chain type transmit power improvement predictor 136 can more accurately assess the potential benefits of engaging the dual transmit mode, ensuring that the device only switches to this mode when the anticipated power increase justifies the additional power consumption and thermal output. This approach not only optimizes power efficiency but also enhances device performance by preventing unnecessary activation of dual transmit mode, thereby conserving battery life and maintaining device temperature within acceptable limits.

Considering an antenna pattern misalignment factor is beneficial for the effective chain type transmit power improvement predictor 136 because it can directly affect the accuracy of the predicted transmit power increase as well. Antenna pattern misalignment refers to the deviation in the orientation or configuration of the antennas' radiation patterns, which can lead to inefficient signal propagation and reception.

When antennas are misaligned, the intended signal paths may not overlap optimally, resulting in reduced effective isotropic radiated power (EIRP) and potential signal cancellation. This misalignment can diminish the benefits of dual transmit mode by causing interference and reducing the overall transmission efficiency. By accounting for the antenna pattern misalignment factor, the effective chain type transmit power improvement predictor 136 can more precisely evaluate whether the dual transmit mode will provide a meaningful improvement in communication performance. This ensures that the device only engages the dual transmit mode when the anticipated power increase justifies the additional power consumption and thermal output, thereby optimizing power efficiency, enhancing device performance, and maintaining device temperature within acceptable limits.

Incorporating a waveform cancellation factor into the effective chain type transmit power improvement predictor 136 is beneficial because it can further impact the accuracy of predicting the expected transmit power increase amount. Waveform cancelation occurs when the signals transmitted from multiple antennas interfere destructively, leading to a reduction in the effective isotropic radiated power (EIRP) and overall communication performance.

This phenomenon can be particularly pronounced in dual transmit systems where the phase and amplitude of signals from different antennas may not align precisely, resulting in partial or effective chain type transmit power improvement predictor 136 can more accurately assess the potential benefits of engaging the dual transmit mode, ensuring that the device only switches to this mode when the anticipated power increase justifies the additional power consumption and thermal output. This approach not only optimizes power efficiency but also enhances device performance by preventing unnecessary activation of dual transmit mode, thereby conserving battery life and maintaining device temperature within acceptable limits

By performing these operations, a method and mechanism is provided in the electronic device 100 to determine, by one or more processors 109, whether an anticipated increase in transmit power surpasses a predefined threshold. In one or more embodiments, this determination is based on a combination of factors.

Illustrating by example, in one or more embodiments the factors include an antenna imbalance factor occurring between antennas of multiple antennas operable with a communication device 118 of the electronic device 100, an implementation factor associated with the physical design of the electronic device 100, and a maximum power reduction factor corresponding to resource block and modulation allocations assigned by a network 137 in communication with the communication device 118.

In one or more embodiments, when the anticipated increase in transmit power exceeds the threshold, the method comprises causing the communication device 118 to operate in the dual transmit mode of operation. This approach ensures that the dual transmit mode is engaged only when it provides a meaningful improvement in communication performance, thereby optimizing power consumption and enhancing device efficiency.

It should be noted that the threshold need not necessarily static. Illustrating by example, in one or more embodiments the one or more processors 109 can adjust the threshold as a function of a state of operation of an energy storage device powering the one or more processors 109.

For instance, adjusting the threshold for determining whether to operate in dual transmit mode or single transmit mode when the battery is low can significantly enhance the device's power efficiency and prolong battery life. When the battery level is low, conserving energy becomes a priority to ensure the device remains operational for as long as possible. By increasing the threshold, the device can be configured to favor single transmit mode, which typically consumes less power compared to dual transmit mode.

This adjustment helps to minimize the additional current drain associated with dual transmit operations, thereby reducing the risk of depleting the battery prematurely. As a result, this approach not only optimizes power consumption but also maintains necessary communication capabilities, ensuring that the device can continue to function effectively even under low battery conditions.

The electronic device 100 can include one or more sensors 129. Illustrating by example, in one embodiment, the one or sensors 129 comprise one or more flex sensors, operable with the one or more processors 109, to detect a bending operation that causes the first device housing 102 to pivot about the hinge assembly 101 relative to the second device housing 103, thereby transforming the electronic device 100 into a deformed geometry. In one or more embodiments, the one or more flex sensors can detect initiation of the first device housing 102 pivoting, bending, or deforming about the hinge assembly 101 relative to the second device housing 103.

Other components 135 of the electronic device 100 may include a microphone, an earpiece speaker, a loudspeaker, key selection sensors, a touch pad sensor, a touch screen sensor, a capacitive touch sensor, and one or more switches. Touch sensors may be used to indicate whether any of the user actuation targets present on the flexible display 141 are being actuated. Alternatively, touch sensors disposed along the first device housing 102 and/or the second device housing 103 can be used to determine whether the electronic device 100 is being touched at side edges or major faces of the electronic device 100 by a surface, hands, keys, or other objects. The touch sensors can include surface and/or housing capacitive sensors in one embodiment.

The other components 135 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion. In one embodiment the motion detectors are also operable to detect movement, and direction of movement, of the electronic device 100 by a user.

In one or more embodiments, the other components 135 include a gravity detector. For example, as one or more accelerometers and/or gyroscopes may be used to show vertical orientation, constant, or a measurement of tilt relative to gravity. The other components 135 operable with the one or more processors 109 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components and still be within the scope of the present disclosure.

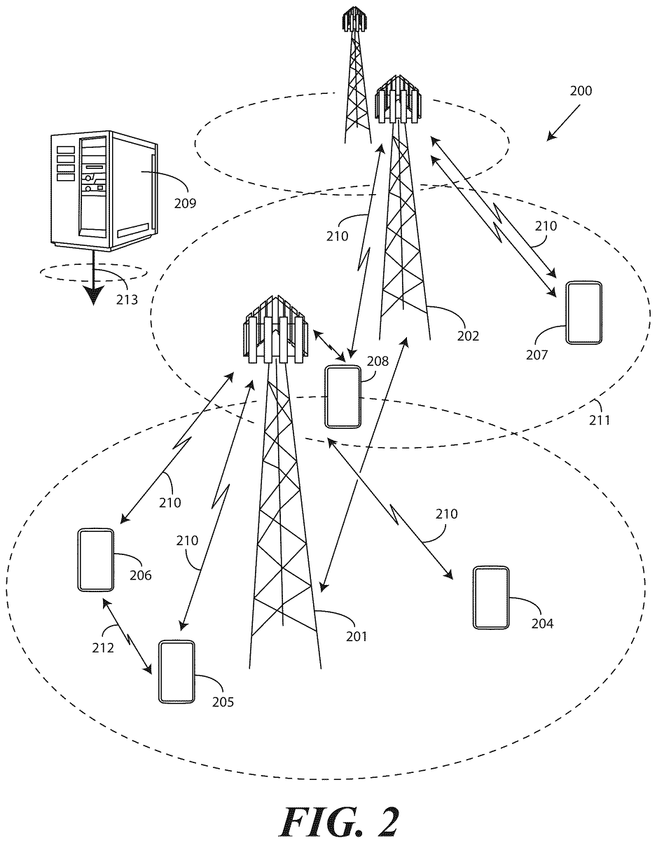

Turning now to FIG. 2, illustrated therein is an example of wireless communications system 200 that supports power efficient transmit diversity in accordance with aspects of the present disclosure. Wireless communications system 200 may include one or more base nodes 201,202, one or more user equipments (UEs) 203,204,205,206,207,208, and core network 209.

In one or more embodiments, the wireless communications system 200 may support various radio access technologies. Illustrating by example, the wireless communications system 200 may be or may include a 4G network, such as an LTE network or an LTE-Advanced (LTE-A) network.

In other embodiments, the wireless communications system 200 may be or may include a 5G network, such as a new radio (NR) network. In still other embodiments, the wireless communications system 200 may be a combination of a 4G network and a 5G network.

The wireless communications system 200 may even support radio access technologies beyond 5G. Additionally, the wireless communications system 200 may support different transmission modes, such as time division multiple access (TDMA), frequency division multiple access (FDMA), or code division multiple access (CDMA), and so forth.

The one or more base nodes 201,202 may be dispersed throughout a geographic region to form the backbone infrastructure of wireless communications system 200. The one or more of base nodes 201,202 may be, may include, or may be referred to as a base transceiver station, an access point, a NodeB, an evolution NodeB (eNB), a next-generation NodeB (gNB), or other suitable terminology.

In one or more embodiments, the base nodes 201,202 and UEs 203,204,205,206,207,208 may communicate via communication links 210, which may be a wireless or wired connection. In an example, base node 202 and UE 207 may wirelessly communication over a user unit (Uu) interface.

Base node 202 may provide geographic coverage area 211 for which base node 202 may support services (e.g., voice, video, packet data, messaging, broadcast, etc.) for one or more UEs 207,2084 within geographic coverage area 211. For example, base node 202 and UE 207 may support wireless communication of signals related to services (e.g., voice, video, packet data, messaging, broadcast, etc.) according to one or multiple radio access technologies.

In some implementations, base node 202 may be moveable. For example, base node 202 may be a satellite associated with a non-terrestrial network. In some implementations, different geographic coverage areas 211 associated with the same or different radio access technologies may overlap, but the different geographic coverage areas 211 may be associated with different base nodes 202.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

One or more UEs 203,204,205,206,207,208 may be dispersed throughout a geographic region of wireless communications system 200. UEs 203,204,205,206,207,208 may include or may be referred to as a mobile device, a wireless device, a remote device, a handheld device, or a subscriber device, or some other suitable terminology. In some implementations, UEs 203,204,205,206,207,208 may be referred to as a unit, a station, a terminal, or a client, among other examples. Additionally, or alternatively, the UEs 203,204,205,206,207,208 may be referred to as an Internet-of-Things (IoT) device, an Internet-of-Everything (IoE) device, or machine-type communication (MTC) device, among other examples. In some implementations, UEs 203,204,205,206,207,208 may be stationary in wireless communications system 200. In some other implementations, UEs 203,204,205,206,207,208 may be mobile in wireless communications system 200.

One or more UEs 203,204,205,206,207,208 may be devices in different forms or having different capabilities. UE 205 may be capable of communicating with various types of devices, such as base nodes 201, other UEs 206, or network equipment (e.g., core network 209, a relay device, an integrated access and backhaul (IAB) node, or another network equipment), as shown in FIG. 2. Additionally, or alternatively, UE 205 may support communication with other base nodes 202 or UEs 206, which may act as relays in the wireless communications system 200. In some embodiments, the one or more UEs 203,204,205,206,207,208 may further be capable of communicating with space-based infrastructure in the form of geo-stationary or moving space based satellites.

UE 205 may also be able to support wireless communication directly with other UEs 206 over communication link 212. For example, UE 204 may support wireless communication directly with another UE 206 over a device-to-device (D2D) communication link. In some implementations, such as vehicle-to-vehicle (V2V) deployments, vehicle-to-everything (V2X) deployments, or cellular-V2X deployments, the communication link 212 may be referred to as a side link. For example, a UE 205 may support wireless communication directly with another UE 206 over a PC5 interface. UEs 203,204,205,206,207,208 can use transmit diversity according to aspects of the present disclosure to increase transmit power levels in a power efficient manner.

Base node 202 may support communications with core network, or with another base nodes, or both. For example, base node 202 may interface with the core network through one or more backhaul links 213 (e.g., via an S1, N2, N2, or another network interface). The base nodes 202 may communication with each other over backhaul links 213 (e.g., via X2, Xn, or another network interface). The core network may support user authentication, access authorization, tracking, connectivity, and other access, routing, or mobility functions. The core network may be an evolved packet core (EPC), or a 5G core (5GC)

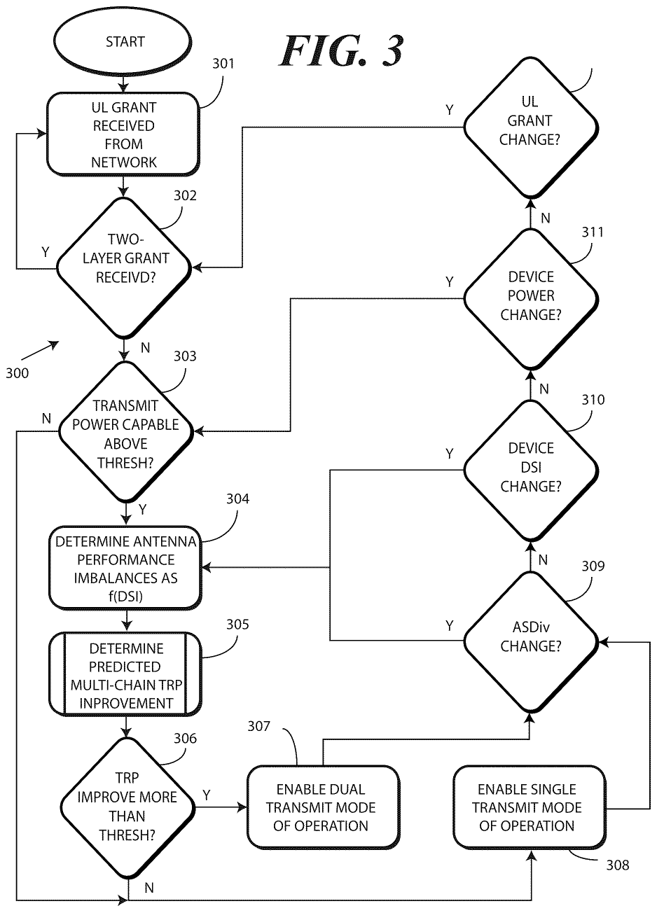

Turning now to FIG. 3, illustrated therein is one explanatory method 300 for efficient deployment of transmit diversity in wireless communication devices, examples of which include the UEs (203,204,205,206,207,208) operating in the wireless communications system (200) of FIG. 2 above. Beginning at step 301, an uplink grant is received from the network.

In the context of wireless communication, when discussing a “UL grant,” the term refers to an “uplink grant.” This is a permission provided by the network to a device, such as a smartphone, allowing the device to send data back to the network. Consider this as the network giving the device a green light to start transmitting data.

At step 301, when a UL grant is received from the network, the grant indicates that the network has given the device the go-ahead to transmit data. This is an important step because this stage allows the device to decide how data will be sent. The device can choose between using a single transmit mode or a dual transmit mode, depending on various factors like power efficiency and network conditions.

In simpler terms, receiving a UL grant is like getting a ticket to speak at a meeting. Once your device has this ticket, the device can determine the most effective way to deliver its message, ensuring the use of the appropriate amount of power and resources to communicate effectively with the network.

Decision 302 determines if the grant received at step 301 is a two-layer grant. To understand this, consider the following:

In wireless communication, an uplink grant is a permission given by the network to a device, such as a smartphone, allowing the device to send data back to the network. Consider this as the network providing the device with a green light to begin transmitting data.

A ‘two-layer” grant refers to a specific type of uplink grant that allows the device to use two separate data streams, or “layers,” for sending data. Using two layers can increase the amount of data that can be sent at once. This is similar to having two lanes on a highway instead of one, which allows more cars to travel simultaneously.

Decision 302 checks whether the uplink grant received is a two-layer grant. This decision is important because the outcome determines how the device will manage data transmission. If the grant is a two-layer grant, the device can use both layers to send more data, potentially improving data speed and efficiency. In simpler terms, decision 302 is like checking if the network has given the device permission to use a “fast lane” for sending data. If the answer is yes, the device can send more data at once, making the communication faster and more efficient. If not, the device will use the regular “single lane” for data transmission and the method 300 will move to decision 303.

At decision 303, the method 300 determines if the electronic device is capable of transmitting with an uplink transmission power exceeding a threshold. In one or more embodiments, decision 303 determines whether the electronic device comprises a communication device capable of operating in a single transmit mode of operation having associated therewith a first power class and a dual transmit mode of operation having associated therewith a second power class that is a higher power class than the first power class. If so, the method 300 moves to step 304. Otherwise, a single transmit mode of operation is used at step 308.

In one or more embodiments, step 304 determines antenna imbalances by analyzing the data per device state (DSI state) and antenna selection. In one or more embodiments, this process involves characterizing device performance data for various DSI states, which correspond to specific usage scenarios such as being held in hand, placed against the body, or in open/closed configurations.

In one or more embodiments, the device utilizes a lookup table that maps these DSI states to expected antenna performance metrics, allowing the device to assess imbalances based on real-time conditions. Techniques for determining antenna imbalances include measuring signal strength variations across different antennas, analyzing phase and amplitude discrepancies, and employing machine learning algorithms to predict performance based on historical data.

Each technique offers distinct advantages: signal strength measurements provide immediate feedback on current performance, phase and amplitude analysis offers detailed insights into the nature of imbalances, and machine learning enables adaptive and predictive adjustments to optimize antenna performance. By integrating these techniques, the electronic device can dynamically adjust its operation to mitigate the effects of antenna imbalances, thereby enhancing communication efficiency and user experience.

At process block 305, the method 300 comprises predicting, by one or more processors of an electronic device, an expected transmit power increase as a function of a combination of one or more factors corresponding to operating characteristics of the electronic device and a resource allocation factor corresponding to a resource allocation provided by a network with which a communication device of the electronic device is in communication. In one or more embodiments, the one or more factors corresponding to the operating characteristics of the electronic device comprise one or both of an antenna imbalance factor occurring between antennas of a plurality of antennas carried by the electronic device and/or an antenna isolation factor associated with the antennas of the plurality of antennas.

In one or more embodiments, the resource allocation factor corresponding to the resource allocation provided by the network comprises a maximum power reduction allowed by the network due to the resource allocation. In one or more embodiments, the one or more factors corresponding to the operating characteristics of the electronic device comprise both the antenna imbalance factor and the antenna isolation factor, and the antenna isolation factor is constant for all resource allocation factors corresponding to the resource allocation provided by the network.

In one or more embodiments, decision 306 then comprises comparing, by the one or more processors, the expected transmit power increase to a threshold. In one or more embodiments, the threshold is defined as a function of an amount of additional current drawn by the communication device when operating in the dual transmit mode of operation compared with operation in the single transmit mode of operation. As noted above, in one or more embodiments the threshold is between 0.5 decibels (dB) and 1.0 dB, inclusive. However, other thresholds will be obvious to those of ordinary skill in the art having the benefit of this disclosure.

In one or more embodiments, when the expected power increase exceeds the threshold, step 307 causing, by the one or more processors, the communication device to operate in the dual transmit mode of operation. When the expected power increase falls below the threshold, the step 308 comprises causing, by the one or more processors, the communication device to operate in the single transmit mode of operation.

In one or more embodiments, the causing the communication device to operate in the single transmit mode of operation at step 308 occurs despite the communication device receiving a network request for the communication device to operate in the dual transmit mode of operation. Embodiments of the disclosure contemplate that while some networks may require a dual mode of operation to access certain features and bandwidths, networks typically do not revoke the uplink grant simply because UE is operating in a single transmit mode of operation.

In one or more embodiments, process block 305 computes the expected transmit power increase amount only at certain times. Illustrating by example, in one or more embodiments the effective chain type transmit power improvement predictor determines the expected transmit power increase amount when an uplink grant from the network has changed, as determined by decision 312, device power has changed, the data per device state (DSI) has changed, as determined by decision 311, or the antenna switch diversity (ASdiv) has changed, as determined by decision 309. Other criteria used to trigger the computation of the expected transmit power increase amount 133 will be obvious to those of ordinary skill in the art having the benefit of this disclosure. Illustrating by example, a change in DSI, determined by decision 310, can also be used to cause process block 305 to compute the expected transmit power increase amount.

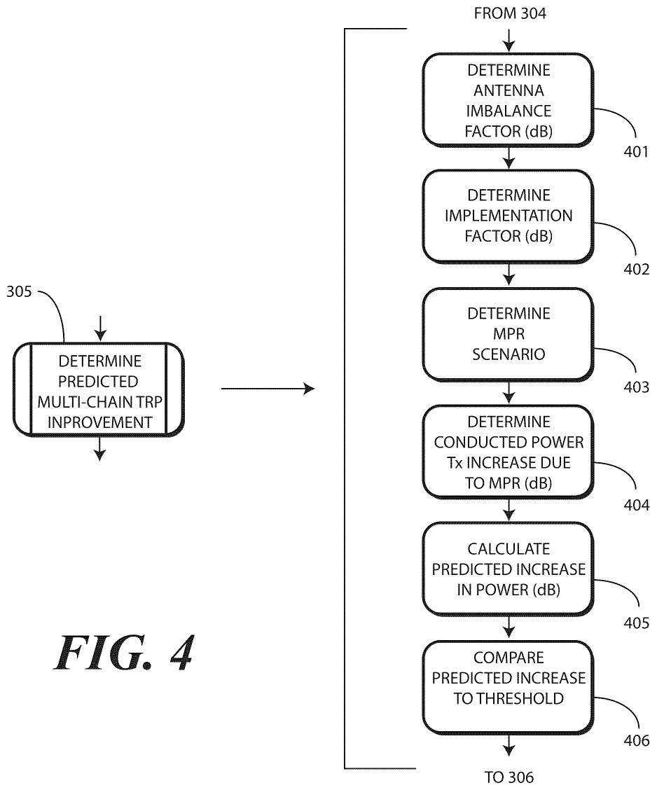

Process block 305 can be performed in a variety of ways. Illustrating by example, turning now to FIG. 4, illustrated therein are one or more method steps that can be used to perform process block 305.

In one or more embodiments, step 401 of FIG. 4 involves determining an antenna imbalance factor in decibels for an electronic device. This can be achieved through multiple techniques.

One approach is to measure signal strength variations across different antennas, providing immediate feedback on current performance and allowing for real-time adjustments. This technique is advantageous as it offers a direct and straightforward method to assess antenna performance discrepancies.

Another method involves analyzing phase and amplitude discrepancies between antennas, which offers detailed insights into the nature of imbalances and helps in understanding the root causes of performance issues. This approach is beneficial for its precision and ability to identify specific areas of misalignment.

Additionally, machine learning algorithms can be employed to predict performance based on historical data, enabling adaptive and predictive adjustments to optimize antenna performance. The advantage of using machine learning lies in the capability to continuously refine predictions and improve accuracy over time, making this a robust solution for dynamic environments. By integrating these techniques, the electronic device can dynamically adjust operations to mitigate the effects of antenna imbalances, thereby enhancing communication efficiency and user experience.

In one or more embodiments, step 402 determines an implementation factor in decibels for an electronic device. In one or more embodiments, the implementation factor is determined in the factory by the manufacturer and is set as a constant. Illustrating by example, the implementation factor may be −0.5 dB.

In one or more embodiments, the “implementation factor” refers to a consistent value used for efficiently deploying transmit diversity in wireless communication devices. This factor accounts for specific design and environmental characteristics that can affect the performance of the device's antennas. Here's a simplified explanation:

In one or more embodiments, the implementation factor is used to adjust calculations related to the device's ability to transmit signals effectively. This factor assists in predicting the performance of the device when utilizing two antennas to send data, a configuration referred to as dual transmit mode.

In real-world scenarios, designing two antennas that perform identically is challenging due to physical constraints and environmental factors. For example, how a person holds the device, or the surrounding environment can impact signal quality. The implementation factor helps account for these variations.

In one or more embodiments, the components of the implementation factor comprise antenna isolation, which refers to how well the antennas can operate without interfering with each other. Poor isolation can lead to signal degradation.

Antenna pattern misalignment involves the orientation and configuration of the antennas' radiation patterns. Misalignment can cause inefficient signal propagation. Waveform cancelation occurs when signals from different antennas interfere with each other, reducing the overall signal strength.

In use, the implementation factor serves as an “overhead” loss in uplink transmit power. In one or more embodiments, the implementation factor is generally determined during the design phase and remains unchanged. This factor is utilized in calculations to decide whether the device operates in dual transmit mode or reverts to a single transmit mode, based on whether the benefits of dual transmission outweigh the drawbacks such as increased power consumption and heat generation.

At step 403 of FIG. 4, a maximum power reduction (MPR) scenario can be determined. At step 404, a conducted power transmit§ increase due to MPR can be determined. In one or more embodiments, step 404 is performed by accessing the relevant specifications that define the allowed power reductions for various resource block (RB) allocations and modulation schemes. These specifications, such as those outlined by 3GPP, provide detailed tables that indicate the MPR values applicable to different transmission scenarios.

For instance, FIG. 5 illustrates several MPR scenarios, including edge RB allocations in modulation schemes, examples of which include QPSK, 16 QAM, 64 QAM, and 256 QAM. Each scenario is associated with a specific MPR value, which directly impacts the expected transmit power increase. By referencing these tables, the expected transmit power increase for each MPR scenario can be calculated by considering the difference between the power class of the single transmit mode and the dual transmit mode. This calculation allows the device to assess whether the anticipated power increase justifies the additional power consumption and thermal output associated with operating in the dual transmit mode

Step 405 the comprises predicting, by one or more processors of the electronic device, an expected transmit power increase as a function of a combination of one or more factors corresponding to operating characteristics of the electronic device and a resource allocation factor corresponding to a resource allocation provided by a network with which a communication device of the electronic device is in communication. Step 406 then compares, by one or more processors, the expected transmit power increase to a threshold. When the expected power increase exceeds the threshold, causing, by the one or more processors, the communication device to operate in the dual transmit mode of operation.

Turning now to FIG. 5, illustrated therein is an explanatory table 500 showing one or more expected power increase exceeds the thresholds, the factors and values used to calculate these expected power increase exceeds the thresholds, and the decisions, shown in column 514, made regarding whether to operate in a single transmit mode of operation or a dual transmit mode of operation.

As noted above, in one or more embodiments the expected transmit power increase, which is shown in column 513, is calculated as a function of a combination of one or more factors corresponding to operating characteristics of an electronic device and a resource allocation factor, shown in column 512, corresponding to a resource allocation, shown in column 511, provided by a network with which a communication device of the electronic device is in communication. In one or more embodiments, the one or more factors corresponding to the operating characteristics of the electronic device comprise one or both of an antenna imbalance factor, shown in column 509, occurring between antennas of a plurality of antennas carried by the electronic device and/or an antenna isolation factor associated with the antennas of the plurality of antennas.

In this illustrative table 500, the threshold to which the expected power increase exceeds the threshold is compared is 1.0 dB. The different use cases are shown in rows 501,502,503,504, 505,506,507,508, with rows 501,502,503 having a sufficient expected power increase exceeds the threshold to justify causing the communication device to operate in the dual transmit mode of operation. By contrast, since the expected power increase exceeds the threshold of rows 504,505,506,507,508 falls below the threshold, one or more processors of the electronic device will cause the communication device to operate in the single transmit mode of operation.

One note in the table 500 of FIG. 5 is that the implementation factor, shown in column 510, is a constant except for the ideal case shown in row 505, which does not occur in the field, and an intentionally poorly designed case shown in row 508 that would also not typically occur in the field when best engineering practices are used in designing the electronic device. This implementation factor, which can be driven by a complex set of variables including antenna patterns over channel bandwidth, the channel itself, the physical design of the device itself, and other factors, represents an overhead of transmission power loss due to real world scenarios. While it can be calculated on the fly in the electronic device, in many situations using a constant value will suffice.

Additionally, the antenna imbalance shown in column 509 can frequently be defined by the manufacturer across a number of use cases, e.g., whether the electronic device is being held by the left hand, the right hand, is in a pocket, is being held by the left hand against the head, the right hand against the head, etc., and stored in a look-up table. Similarly, the power increase per MPR scenario shown in column 512 can be obtained from standards and stored in a table as well. Thus, in practice it is possible to determine the expected power increase exceeds the threshold very quickly from look-up tables without performing measurements on the fly.

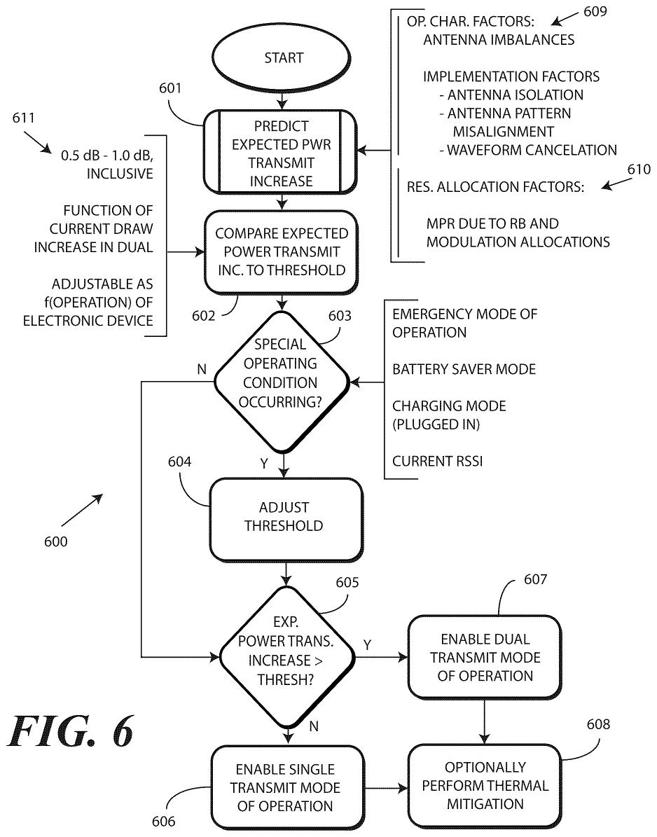

Turning now to FIG. 6, illustrated therein is another explanatory method 600 in accordance with one or more embodiments of the disclosure. Beginning at process block 601, in one or more embodiments the method 600 predicts, by one or more processors of an electronic device, an expected transmit power increase as a function of a combination of one or more factors 609 corresponding to operating characteristics of the electronic device and a resource allocation factor 610 corresponding to a resource allocation provided by a network with which a communication device of the electronic device is in communication.

In the illustrative embodiment of FIG. 6, the one or more factors 609 corresponding to the operating characteristics of the electronic device comprise one or both of an antenna imbalance factor occurring between antennas of a plurality of antennas carried by the electronic device and/or an antenna isolation factor associated with the antennas of the plurality of antennas. As shown in FIG. 6, in this illustrative embodiment the resource allocation factor 610 corresponding to the resource allocation provided by the network comprises a maximum power reduction allowed by the network due to the resource allocation.

At step 602, the method 600 compares, by the one or more processors, the expected transmit power increase to a threshold 611. In one or more embodiments, the threshold 611 falls within a range of between 0.5 dB and 1.0 dB, inclusive, although other thresholds will be obvious to those of ordinary skill in the art having the benefit of this disclosure. One thing to note, however, is that as shown in FIG. 6 in some situations the threshold can be changed.

In one or more embodiments, the threshold 611 of FIG. 6 is dynamically adjustable based on the operating states of the electronic device to optimize power efficiency and performance. When the electronic device is coupled to a charger, the threshold may be zeroed, allowing the device to operate in dual transmit mode without regard to the additional power consumption. This occurs because the device is not constrained by battery limitations, and maximizing communication performance becomes a priority.

Conversely, when the battery is low, the threshold may be increased to conserve energy and prolong battery life. In this state, the device prioritizes power efficiency over performance, ensuring that dual transmit mode is only engaged when it provides a significant improvement in communication capabilities. This dynamic adjustment of the threshold ensures that the device operates optimally under varying power conditions, balancing the need for performance with the requirement of power conservation.

Illustrating by example, in one or more embodiments decision 603 determines whether a special operating condition is occurring in the electronic device. Examples include whether the electronic device is operating in an emergency mode of operation, a battery saver mode of operation, a charging mode of operation, or whether current received signal strength indicators (RSSI) exceed a predefined threshold. Where a special condition is occurring, step 604 can adjust the threshold 611.

For instance, in one or more embodiments step 602 can comprise adjusting, by the one or more processors prior to the comparing, the threshold 611 as a function of one or more operating states of the electronic device. In one or more embodiments, the one or more operating states comprise a low battery mode of operation and the adjusting comprises increasing the threshold. In other embodiments, the one or more operating states comprise a charging mode of operation and the adjusting comprises zeroing the threshold. Other operating states and adjustments suitable for performance at step 604 will be obvious to those of ordinary skill in the art having the benefit of this disclosure.

Decision 605 determines whether the expected transmit power increase exceeds the threshold d611. Where it does, step 607 causes a communication device to operate in a dual transmit mode of operation. However, when the expected power increase falls below the threshold, step 606 comprises causing, by the one or more processors, the communication device to operate in the single transmit mode of operation. In one or more embodiments, step 606 causes the communication device to operate in the single transmit mode of operation despite the communication device receiving a network request for the communication device to operate in the dual transmit mode of operation.

At optional step 608, the method 600 can perform, by the one or more processors, one or more thermal mitigation techniques. In one or more embodiments, step 608 only occurs when the expected power increase exceeds the threshold. Examples of thermal mitigation techniques comprise reducing a brightness of a display of the electronic device. Others will be obvious to those of ordinary skill in the art having the benefit of this disclosure.

Embodiments of the disclosure contemplate that when the expected transmit power increase surpasses the threshold, engaging the dual transmit mode can lead to increased power consumption, which in turn may result in elevated device temperatures. Performing thermal mitigation techniques at step 608 of FIG. 6 is beneficial as these techniques help manage the thermal output of the device, ensuring that the device operates within safe temperature limits.

Elevated temperatures can adversely affect the performance and longevity of electronic components, potentially leading to thermal throttling, reduced battery life, and even permanent damage to the device. By implementing thermal mitigation strategies, such as reducing the brightness of the display or adjusting the device's power settings, the device can maintain optimal performance while minimizing the risk of overheating.

This approach not only protects the device's hardware but also enhances the user experience by preventing discomfort associated with excessive heat generation. Additionally, thermal management ensures compliance with regulatory standards for device safety and performance, further underscoring the importance of these measures in the context of dual transmit mode operations.

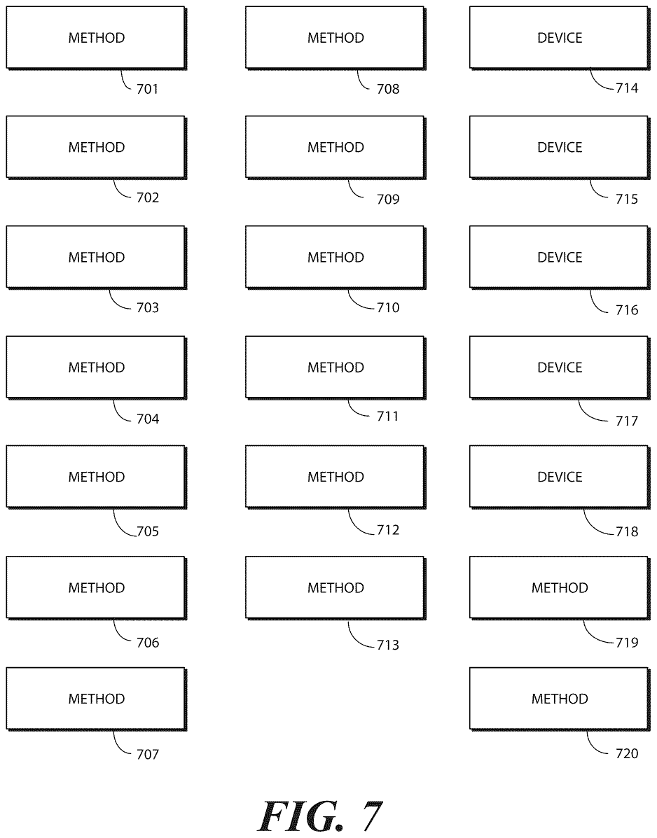

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device configured for operation in either a dual transmit mode of operation or single transmit mode of operation comprises predicting, by one or more processors of the electronic device, an expected transmit power increase as a function of a combination of one or more factors corresponding to operating characteristics of the electronic device and a resource allocation factor corresponding to a resource allocation provided by a network with which a communication device of the electronic device is in communication. At 701, the method comprises comparing, by the one or more processors, the expected transmit power increase to a threshold/At 701, when the expected power increase exceeds the threshold, the method comprises causing, by the one or more processors, the communication device to operate in the dual transmit mode of operation.

At 702, the method of 701 further comprises, when the expected power increase falls below the threshold, causing, by the one or more processors, the communication device to operate in the single transmit mode of operation. At 703, the causing the communication device to operate in the single transmit mode of operation of 701 occurs despite the communication device receiving a network request for the communication device to operate in the dual transmit mode of operation.

At 704, the one or more factors of 701 corresponding to the operating characteristics of the electronic device comprise one or both of an antenna imbalance factor occurring between antennas of a plurality of antennas carried by the electronic device and/or an antenna isolation factor associated with the antennas of the plurality of antennas. At 705, the resource allocation factor corresponding to the resource allocation provided by the network of 704 comprises a maximum power reduction allowed by the network due to the resource allocation.

At 706, the threshold of 705 is defined as a function of an amount of additional current drawn by the communication device when operating in the dual transmit mode of operation compared with operation in the single transmit mode of operation. At 707, the threshold of 706 is between 0.5 decibels (dB) and 1.0 dB, inclusive. At 708, the one or more factors of 706 corresponding to the operating characteristics of the electronic device comprise both the antenna imbalance factor and the antenna isolation factor, and the antenna isolation factor is constant for all resource allocation factors corresponding to the resource allocation provided by the network.

At 709, the method of 701 further comprises adjusting, by the one or more processors prior to the comparing, the threshold as a function of one or more operating states of the electronic device. At 710, the one or more operating states of 709 comprise a low battery mode of operation and the adjusting comprises increasing the threshold. At 711, the one or more operating states of 709 comprise a charging mode of operation and the adjusting comprises zeroing the threshold.

At 712, the method of 701 further comprises performing, by the one or more processors, one or more thermal mitigation techniques when the expected power increase exceeds the threshold. At 713, the one or more thermal mitigation techniques of 712 comprise reducing a brightness of a display of the electronic device.

At 714, an electronic device comprises a communication device capable of operating in a single transmit mode of operation having associated therewith a first power class and a dual transmit mode of operation having associated therewith a second power class that is a higher power class than the first power class. At 714, the electronic device comprises one or more processors operable with the communication device.

At 714, the one or more processors are configured to determine an expected transmit power increase amount for the communication device as a function of a combination of electronic device operating characteristic factors and a resource allocation factor associated with a resource allocation provided to the communication device by a network. At 714, the one or more processors only cause the communication device to operate in the dual transmit mode of operation when the expected transmit power increase amount exceeds an expected power increase threshold.

At 715, the communication device of 714 uses a first transmit chain and a second transmit chain when operating in the dual transmit mode of operation and omits the use of the second transmit chain when operating in the single transmit mode of operation. At 716, the communication device of 714 comprises a plurality of antennas and the electronic device operating characteristic factors comprise an antenna imbalance factor occurring between antennas of the plurality of antennas carried by the electronic device and one or more implementation factors characterized by a physical state of the electronic device.

At 717, the one or more implementation factors of 716 comprise an antenna isolation factor associated with antennas of the plurality of antennas, an antenna pattern misalignment factor associated with the antennas of the plurality of antennas, a waveform cancelation factor associated with the antennas of the plurality of antennas, and/or combinations thereof. At 718, the resource allocation factor of 717 comprises a maximum power reduction factor corresponding to resource block and modulation allocations assigned by the network.

At 719, a method in an electronic device capable of dual transmit mode operation comprises determining, by one or more processors, whether an expected transmit power increase amount determined from a combination of an antenna imbalance factor occurring between antennas of a plurality of antennas operable with a communication device of the electronic device, an implementation factor associated with a physical design of the electronic device, and a maximum power reduction factor corresponding to resource block and modulation allocations assigned by a network in communication with the communication device exceeds a threshold. At 719, when the expected transmit power increase amount exceeds the threshold, the method comprises causing the communication device to operate in the dual transmit mode of operation.

At 720, the method of 719 further comprises adjusting, by the one or more processors, the threshold as a function of a state of operation of an energy storage device powering the one or more processors.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in alternate embodiments, the electronic device may incorporate additional features to enhance adaptability and efficiency in various operational environments. For instance, the communication device may be equipped with a dynamic antenna system that adjusts the configuration based on real-time environmental feedback, such as user handling or proximity to other electronic devices, to optimize signal quality and power consumption. The processors may also be integrated with machine learning algorithms that continuously refine the criteria for switching between single and dual transmit modes, taking into account historical data and predictive analytics to improve decision-making accuracy.

Furthermore, the device may include a user interface that allows manual override of the automatic mode selection, providing users with the flexibility to prioritize either power efficiency or communication performance based on their immediate needs. Additionally, the device could support multiple power classes beyond the first and second, enabling finer granularity in power management and further optimizing the balance between performance and energy consumption. These alternate embodiments aim to provide a more versatile and user-centric approach to managing transmit diversity in electronic communication devices

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device configured for operation in either a dual transmit mode of operation or single transmit mode of operation, the method comprising:
predicting, by one or more processors of the electronic device, an expected transmit power increase as a function of a combination of one or more factors corresponding to operating characteristics of the electronic device and a resource allocation factor corresponding to a resource allocation provided by a network with which a communication device of the electronic device is in communication;
comparing, by the one or more processors, the expected transmit power increase to a threshold; and
when the expected transmit power increase exceeds the threshold, causing, by the one or more processors, the communication device to operate in the dual transmit mode of operation.

2. The method of claim 1, the method further comprising, when the expected transmit power increase falls below the threshold, causing, by the one or more processors, the communication device to operate in the single transmit mode of operation.

3. The method of claim 2, wherein the causing the communication device to operate in the single transmit mode of operation occurs despite the communication device receiving a network request for the communication device to operate in the dual transmit mode of operation.

4. The method of claim 1, wherein the one or more factors corresponding to the operating characteristics of the electronic device comprise one or both of an antenna imbalance factor occurring between antennas of a plurality of antennas carried by the electronic device and/or an antenna isolation factor associated with the antennas of the plurality of antennas.

5. The method of claim 4, wherein the resource allocation factor corresponding to the resource allocation provided by the network comprises a maximum power reduction allowed by the network due to the resource allocation.

6. The method of claim 5, wherein the threshold is defined as a function of an amount of additional current drawn by the communication device when operating in the dual transmit mode of operation compared with operation in the single transmit mode of operation.

7. The method of claim 6, wherein the threshold is between 0.5 decibels (dB) and 1.0 dB, inclusive.

8. The method of claim 6, wherein the one or more factors corresponding to the operating characteristics of the electronic device comprise both the antenna imbalance factor and the antenna isolation factor, and the antenna isolation factor is constant for all resource allocation factors corresponding to the resource allocation provided by the network.

9. The method of claim 1, further comprising adjusting, by the one or more processors prior to the comparing, the threshold as a function of one or more operating states of the electronic device.

10. The method of claim 9, wherein the one or more operating states comprise a low battery mode of operation and the adjusting comprises increasing the threshold.

11. The method of claim 9, wherein the one or more operating states comprise a charging mode of operation and the adjusting comprises zeroing the threshold.

12. The method of claim 1, further comprising performing, by the one or more processors, one or more thermal mitigation techniques when the expected transmit power increase exceeds the threshold.

13. The method of claim 12, wherein the one or more thermal mitigation techniques comprise reducing a brightness of a display of the electronic device.

14. An electronic device, comprising:
a communication device capable of operating in a single transmit mode of operation having associated therewith a first power class and a dual transmit mode of operation having associated therewith a second power class that is a higher power class than the first power class; and
one or more processors operable with the communication device, wherein the one or more processors are configured to determine an expected transmit power increase amount for the communication device as a function of a combination of electronic device operating characteristic factors and a resource allocation factor associated with a resource allocation provided to the communication device by a network and only cause the communication device to operate in the dual transmit mode of operation when the expected transmit power increase amount exceeds an expected power increase threshold.

15. The electronic device of claim 14, wherein the communication device uses a first transmit chain and a second transmit chain when operating in the dual transmit mode of operation and omits the use of the second transmit chain when operating in the single transmit mode of operation.

16. The electronic device of claim 14, wherein the communication device comprises a plurality of antennas and the electronic device operating characteristic factors comprise:
an antenna imbalance factor occurring between antennas of the plurality of antennas carried by the electronic device; and
one or more implementation factors characterized by a physical state of the electronic device.

17. The electronic device of claim 16, wherein the one or more implementation factors comprise an antenna isolation factor associated with antennas of the plurality of antennas, an antenna pattern misalignment factor associated with the antennas of the plurality of antennas, a waveform cancelation factor associated with the antennas of the plurality of antennas, and/or combinations thereof.

18. The electronic device of claim 17, wherein the resource allocation factor comprises a maximum power reduction factor corresponding to resource block and modulation allocations assigned by the network.

19. A method in an electronic device capable of dual transmit mode operation, the method comprising:
determining, by one or more processors, whether an expected transmit power increase amount determined from a combination of:
an antenna imbalance factor occurring between antennas of a plurality of antennas operable with a communication device of the electronic device;
an implementation factor; and
a maximum power reduction factor corresponding to resource block and modulation allocations assigned by a network in communication with the communication device;
exceeds a threshold and, when the expected transmit power increase amount exceeds the threshold, causing the communication device to operate in the dual transmit mode of operation.

20. The method of claim 19, further comprising adjusting, by the one or more processors, the threshold as a function of a state of operation of an energy storage device powering the one or more processors.
